(19) United States
(12) Patent Application Publication
(10) Pub. No.: US 2023/0093935 A1
(43) Pub. Date: Mar. 30, 2023

(54) COOLED CHARGING CABLE FOR ELECTRIC VEHICLE

(71) Applicant: KBI COSMOLINK CO., LTD., Okcheon-gun (KR)

(72) Inventors: Yong Sun LEE, Seongnam-si (KR); Min Jung WOO, Okcheon-gun (KR); Chang Heun SEOK, Okcheon-gun (KR)

(21) Appl. No.: 17/794,956

(22) PCT Filed: Jul. 27, 2021
(86) PCT No.: PCT/KR2021/009721

§ 371 Date: Jul. 23, 2022

(30) Foreign Application Priority Data
Aug. 26, 2020 (KR) 10-2020-0107926

(51) Int. Cl. B60L 53/302; B60L 53/18; H01B 7/42; H01B 3/30

(52) U.S. Cl. CPC B60L 53/302; B60L 53/18; H01B 7/423; H01B 3/30

(57) ABSTRACT

The present invention relates to a cooled charging cable for an electric vehicle, and the purpose of the present invention is to cool a power line by circulating, through a cooling tube or a refrigerant fluid channel, high-temperature heat generated in the power line when a large-capacity current required for rapid charging is continuously applied to the power line, and arrange the cooling tube or refrigerant fluid channel in a shaping material filled in the cable to cool the power line through a wider surface area in an indirect heat transfer method, so as to enhance the cooling efficiency while preventing the pipe or channel from being in direct contact with the power line, thereby preventing an insulation layer thereof from being deteriorated, damaged, or destructed due to the refrigerant. The cooled charging cable for an electric vehicle according to the present invention comprises: a cable part; at least one conductive part surrounding the outer surface of the cable part; at least one cooling part disposed in the conductive part; and an outer sheath surrounding the cable part and the outer surface of the conductive part.

### TECHNICAL FIELD

The present invention relates to a quick charger for electric vehicles and a cooled charging cable for electric vehicles, which is connected to an electric vehicle, and more specifically, to a cooled charging cable for electric vehicles, which may cool down the heat generated from the power line when a large-capacity current required for quick charging is continuously applied, by circulating through a cooling tube or a refrigerant passage, in which the cooling tube and the refrigerant passage is disposed in a filling object to cool down the heat generated from the power line in an indirect heat transfer manner, thereby increasing cooling efficiency and stably maintaining the circular shape of the finished cable and securing flexibility through the filling object.

### BACKGROUND ART

A conventional charging cable for electric vehicles is installed in a general charger capable of fully charging with a current of 100 A or less over a few hours depending on the battery capacity.

Accordingly, there is a growing demand for increasing the battery capacity to shorten the charging time of the electric vehicle to 30 minutes or less and increasing the driving distance of the electric vehicle. There may be various methods, such as ones using the applied voltage and high frequency, to reduce the time required for charging an electric vehicle while increasing the battery capacity of the electric vehicle, but a common method is to increase the capacity of the applied current.

The current capacity may be increased by thickening the conductor of the power line, but this way has drawbacks of increasing the outer diameter and weight of the finished cable.

If the outer diameter of the finished cable increases, the cable may be less bendable and flexible and, an increase in weight renders it difficult to work on it. If a current of 200 A or more is continuously applied without thickening the conductor, the insulator wrapped around the conductor may be drastically aged by the heat generated from the conductor, shortening the lifespan and causing safety hazards.

To address such shortcomings, a conventional cooled quick charging cable adopts direct cooling in which the power line is inserted in a cooling tube so that the refrigerant directly contacts the insulation layer of the power line and a cooling method in which the cooling tube into which the refrigerant flows is disposed adjacent to the power line.

The method to achieve cooling by bringing the refrigerant in direct contact with the surface of the insulation layer has a risk of changing the physical properties of the insulation layer due to the used refrigerant and resultantly damaging the insulation. The way of placing the refrigerant-introduced cooling tube adjacent to the power line is incapable of sufficient cooling because it touches only part of the surface of the insulation layer of the power line where high heat is generated.

Further, such direct cooling has a shortcoming of an increased outer diameter of the finished charging cable due to the thickened cooling tube where the power is inserted.

The above two cooling methods have more shortcomings, such as causing an unstable placement of the power line or ground line in the charging cable due to movements of the charging cable when the charging connector is plugged in and out for charging the electric vehicle, and deterioration of flexibility of the finished cable.

The conventional quick charging cable has a power line, cooling tube, and signal communication line, as default units, with or without a circular interposer inserted to keep the cable in shape. Repeated charging using the charging cable renders it difficult to keep the default units of the charging cable in stable arrangement for a long term.

Prior art documents in the technical field to which the present invention pertains include Korean Patent Application Publication No. 10-2018-0096259.

### DETAILED DESCRIPTION OF THE INVENTION

### Technical Problems

The present invention has been conceived to address the foregoing issues with the prior art and aims to provide a cooled charging cable for vehicles, which may increase the cooling efficiency by cooling the high heat generated from the power line when a large-capacity current required for quick charging is continuously applied by circulating through a cooling tube or refrigerant passage and placing the cooling tube or refrigerant passage in a filling object to cool in an indirect heat transfer way for a broader area and may prevent deformation, damage, or breakage of the insulation layer due to the refrigerant by avoiding the refrigerant passage from direct contact to the power line.

The present invention also aims to provide a cooled charging cable for vehicles, which may enhance the conductivity of cooling heat by bringing the filling object in tight contact with the entire power line and the entire ground line, thereby enhance cooling efficiency.

The present invention also aims to provide a cooled charging cable for vehicles, which may keep the finished cable stably in circular shape while securing flexibility.

The present invention also aims to provide a cooled charging cable for vehicles, which may significantly reduce the outer diameter, as compared with conventional direct cooling-based cables, by adopting a simplified configuration with a filling object and a cooling tube or a filling object and a refrigerant passage.

### Means to Address the Problems

According to the present invention, a cooled charging cable for an electric vehicle comprises a cable part, at least one conductor part surrounding the cable part, at least one cooling part disposed in the conductor part, and an outer sheath surrounding the cable part and the conductor part.

The cable part includes a ground line and a plurality of power lines disposed to contact each other inside the outer sheath.

The cooled charging cable further comprises a central tension line disposed between the ground and the power lines and formed of any one selected from among carbon, urethane, and glass which are non-metallic fibers.

The conductor part includes a first curved part surrounding any one cable part, a second curved part surrounding another cable part and formed on a side of the first curved part, and a third curved part connecting the first curved part and the second curved part and facing an inner surface of the outer sheath.

The conductor part is formed of a filling object of any one selected from among a thermoplastic elastomer, an olefin-based, urethane-based, amide-based, and polyester-based elastomer.

The cooling part is a cooling tube embedded in the conductor part or a refrigerant passage formed along a length direction of the conductor part. At least one cooling tube or refrigerant passage is disposed in the conductor part, or the cooling tube and the refrigerant passage both are disposed in the conductor part.

### Effects of the Invention

According to the present invention, a cooled charging cable for vehicles may increase the cooling efficiency by cooling the high heat generated from the power line when a large-capacity current required for quick charging is continuously applied by circulating through a cooling tube or refrigerant passage and placing the cooling tube or refrigerant passage in a filling object to cool in an indirect heat transfer way for a broader area and may prevent deformation, damage, or breakage of the insulation layer due to the refrigerant by avoiding the refrigerant passage from direct contact to the power line.

It is possible to enhance the conductivity of cooling heat by bringing the filling object in tight contact with the entire power line and the entire ground line, thereby enhance cooling efficiency.

It is also possible to keep the finished cable stably in circular shape while securing flexibility.

It is also possible to significantly reduce the outer diameter, as compared with conventional direct cooling-based cables, by adopting a simplified configuration with a filling object and a cooling tube or a filling object and a refrigerant passage.

### BRIEF DESCRIPTION OF THE DRAWINGS

FIG. 1 is a cross-sectional view illustrating a cooled charging cable for an electric vehicle according to the present invention.

FIG. 2 is a cross-sectional view illustrating an embodiment of a cooling part applied to a cooled charging cable for an electric vehicle according to the present invention.

### MODE TO PRACTICE THE INVENTION

Advantages and features of the present invention, and methods for achieving the same may be apparent from the embodiments described below with reference to the accompanying drawings.

However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

Hereinafter, exemplary embodiments of the inventive concept will be described in detail with reference to the accompanying drawings. The inventive concept, however, may be modified in various different ways, and should not be construed as limited to the embodiments set forth herein. However, the present invention may be implemented in other various forms and is not limited to the embodiments set forth herein. Like reference denotations may be used to refer to the same or similar elements throughout the specification and the drawings.

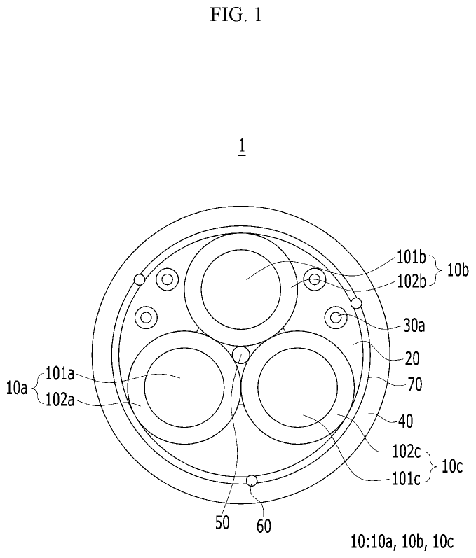

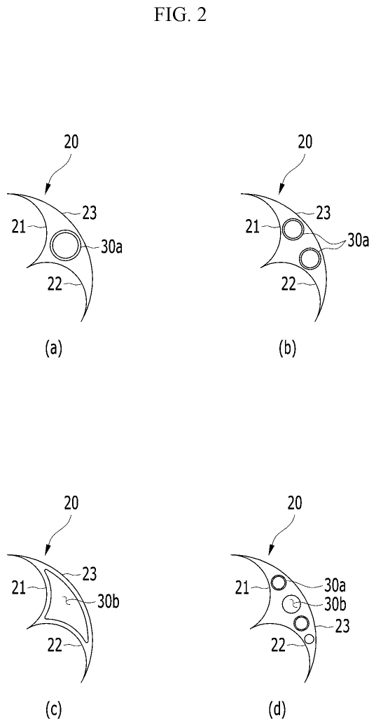

FIG. 1 is a cross-sectional view illustrating a cooled charging cable for an electric vehicle according to the present invention. FIG. 2 is a cross-sectional view illustrating an embodiment of a cooling part applied to a cooled charging cable for an electric vehicle according to the present invention.

According to an embodiment of the present invention, a cooled charging cable 1 for an electric vehicle may include at least one of a plurality of cable parts 10, at least one conductor part 20 surrounding the cable parts 10, at least one cooling part disposed inside the conductor part 20, and an outer sheath 40 surrounding the cable parts 10 and the conductor parts 20 and formed of any one of polyolefin, ethylene propylene synthetic rubber, and thermoplastic elastomer.

The cable parts 10 may include a ground line 10a and a plurality of power lines 10b and 10c disposed to contact each other inside the outer sheath 40.

The ground line 10a and the power lines 10b and 10c may include conductors 101a, 101b, and 101b and insulation layers 102a, 102b, and 101b surrounding the conductors 101a, 101b, and 101b.

In this case, the conductors 101a, 101b, and 101b may be lines formed of metal lines having excellent electrical conductivity. For example, the conductors 101a, 101b, and 101b may include any one or more tin, copper, aluminum, and alloys thereof.

The insulation layers 102a, 102b, and 102b may be formed of a flexible, heat-resistant material.

The material of the insulation layers 102a, 102b, and 102b may be any one of, e.g., ethylene propylene synthetic rubber with heat resistance of 110° C. or silicone rubber with heat resistance of 180° C. (IE2 grade of IEC 60245-3), and heat-resistant soft PVC.

Although not shown in the drawings, the cooled charging cable 1 of an electric vehicle according to an embodiment of the present invention may further include a charger connector (not shown) for electrically connecting the ground line 10a and the power lines 10b and 10c to the electric vehicle to supply power.

The charger connector may be plugged into the connector of the electric vehicle to supply power to the electric vehicle. A quick charger may fully charge the electric vehicle within 20 to 30 minutes.

In this case, the charger connector is a connector of the American/European ‘combo (TYPE1)’ type determined to be adopted in the standard in the future, and is a connector that allows both AC-type normal charging and DC-type quick charging through one connector and may be applied to the cooled charging cable 1 for an electric vehicle according to an embodiment of the present invention.

Furthermore, the cooled charging cable 1 for an electric vehicle according to an embodiment of the present invention may also be applied to the Japanese ‘CHAdeMO’ type or the Renault ‘AC 3-phase’ type as well as the American/European ‘combo (TYPE1)’ type.

The cooled charging cable 1 for an electric vehicle according to an embodiment of the present invention may further include a central tension line 50 disposed between the ground line 10a and the power lines 10b and 10c to reinforce tensile force.

The central tension line 50 may be positioned in the center of the inner space of the outer sheath 40 and be formed of a non-metallic fiber. For example, the central tension line 50 may be formed of any one selected from among carbon, urethane, and glass.

Meanwhile, the cooled charging cable 1 for an electric vehicle, for electrically connecting the electric vehicle to the charger of the electric vehicle may generate heat due to its large current capacity, causing a risk of fire or user anxiety.

The conductor part 20 and the cooling part cool the cable parts 10 to solve the above-described problems.

The conductor part 20 functions to conduct the cooling heat generated from the cooling part to the cable parts 10.

The number of conductor parts 20 to be applied may vary depending on the number of cable parts 10 to be applied.

In other words, the numbers of the cable parts 10 and the conductor parts 20 applied to the cooled charging cable 1 for an electric vehicle according to an embodiment of the present invention are not limited.

FIG. 1 illustrates an example in which one ground line 10a, two power lines 10b and 10c, and three conductor parts 20 are applied.

The shapes of the cooling tube 30a and the refrigerant passage are not limited to the circular or sectoral shapes as shown in the drawings, but may be polygonal, oval, or other various shapes.

The conductor part 20 may include a first curved part 21, a second curved part 22 integrally formed at one end of the first curved part 21, and a third curved part 23 having an end connected with the first curved part 21 and another end connected to the second curved part 22, forming a substantially sectoral shape.

In the conductor part 20 shown on the left of FIG. 1, the first curved part 21 surrounds a certain area of the outer surface of any one power line 10b, the second curved part 22 surrounds a certain area of the outer surface of the ground line 10a, and the third curved part 23 is disposed to face the inner surface of the outer sheath 40.

Accordingly, the conductor part 20 on the left conducts cooling heat to any one power line 10b and the ground line 10a.

In the conductor part 20 on the right, the first curved part 21 surrounds a certain area of the outer surface of any one power line 10b, the second curved part 22 surrounds a certain area of the outer surface of the other power line 10c, and the third curved part 23 is disposed to face the inner surface of the outer sheath 40.

Accordingly, the conductor part 20 on the right conducts cooling heat to one power line 10b and the other power line 10c.

In the conductor part 20 on the lower side, the first curved part 21 surrounds a certain area of the outer surface of the ground line 10a, the second curved part 22 surrounds a certain area of the outer surface of the other power line 10c, and the third curved part 23 is disposed to face the inner surface of the outer sheath 40.

Accordingly, the conductor part 20 on the lower side conducts cooling heat to the ground line 10a and the other power line 10c.

Further, the conductor parts 20 are formed in a sectoral shape and are disposed inside the outer sheath 40 to form a circular shape and support the outer sheath 40, thereby maintaining the circular shape of the cooled charging cable 1 for an electric vehicle according to an embodiment of the present invention.

The conductor part 20 is formed of a filling object of any one selected from among a recyclable thermoplastic elastomer, an olefin-based, a urethane-based, an amide-based, and a polyester-based material, securing the flexibility of the cooled charging cable 1 for an electric vehicle.

Furthermore, the conductor part 20 may be formed of a filling object of any one selected from among a thermoplastic olefin elastomer (TPO), thermoplastic polyurethane (TPU), thermoplastic polyamide (TPAE), and thermoplastic polyester elastomer (TPEE) under conditions requiring a low brittle point of −40° C. to −70° C. and a continuous heat-resistant use temperature of 80° C. or higher.

Further, the conductor part 20 surrounds the cooling part to be described below and thus may stably protect the cooling tube 30a from various impacts.

The conductor part 20 described above may be formed to have the same length as the cable parts 10, for example.

As another example, each conductor 20 may be divided into a plurality pieces to surround each cable part 10.

In this case, a binder 70 and at least one communication line 60 for signal transmission may be disposed between the filling part and the outer sheath 40. The communication line 60 may be partially embedded in the binder 70.

In an example, as the cooling part, the cooling tube 30a may be applied which is embedded in the conductor part 20 and where the refrigerant is circulated as shown in FIG. 2(a).

In this case, a plurality of cooling tubes 30a may be applied to enhance cooling efficiency as shown in FIG. 2(b).

In another example, as the cooling part, a refrigerant passage 30b may be applied which is formed in the conductor part 20 and where the refrigerant passage is circulated as shown in FIG. 2(c).

In this case, a plurality of refrigerant passages 30b may be applied to enhance cooling efficiency.

As shown in FIG. 2(d), at least one cooling tube 30a and refrigerant passage 30b may be disposed in the conductor part 20.

The cooling tube 30a or the refrigerant passage may be disposed along the length direction of the conductor part 20.

Accordingly, the cooling tube 30a or the refrigerant passage 30b allows the refrigerant used to cool the cable part 10 to be repeatedly circulated, thereby cooling the entire conductor part 20 and increasing the surface area contacting the cable part 10 where high heat is generated, to enhance cooling efficiency.

The cold air of the refrigerant may be indirectly transferred to the cable parts 10 via the conductor part 20, stably cooling the cable parts 10.

Specific effects of the cooled charging cable 1 for an electric vehicle according to an embodiment of the present invention, described above, are described below.

The high heat generated from the power lines 10b and 10c when a large-capacity current required for quick charging is continuously applied may be cooled down by circulation through the cooling tube 30a or the refrigerant passage, and the cooling tube 30a or the refrigerant passage 30b is disposed in the conductor part 20 to cool the cable parts 10 in an indirect heat transfer scheme. Thus, it is possible to prevent the insulation layers 102a, 102b, and 102c from deformation, damage, or breakage due to the refrigerant while increasing cooling efficiency.

In other words, if indirect cooling through the conductor part 20 and the cooling part is performed as in the cooled charging cable 1 for an electric vehicle according to an embodiment of the present invention, the cable parts 10 may be cooled down within a stable temperature range, preventing the cable parts 10 from being excessively cooled down to cause functional errors unlike the conventional direct cooling-based cables.

The conductor part 20 may be brought in tight contact with the entirety of the ground line 10a and the power lines 10b and 10c, enhancing the conductivity of cooling heat and hence cooling efficiency.

It is also possible to keep the finished cable stably in circular shape through the conductor part 20 while securing flexibility.

It is possible to significantly reduce the outer diameter, as compared with the conventional direct cooling-type cable, by applying a simplified configuration including the conductor part 20 and cooling tube 30a or the conductor part 20 and the refrigerant passage 30b.

It will be appreciated by one of ordinary skill in the art that the present disclosure may be implemented in other various specific forms without changing the essence or technical spirit of the present disclosure. Thus, it should be noted that the above-described embodiments are provided as examples and should not be interpreted as limiting. It should be noted that the scope of the present invention is defined by the appended claims rather than the described description of the embodiments and include all modifications or changes made to the claims or equivalents of the claims.

### LEGEND OF REFERENCE NUMBERS

1: cooled charging cable for electric vehicle

10: cable part 10a: ground line

101a, 101b, 101c: conductor part 102a, 102b, 102c: insulation layer

10b, 10c: power line 20: conductor part

21: first curved part 22: second curved part

23: third curved part 30a: cooling tube

30b: refrigerant passage 40: outer sheath

50: high tension line 60: communication line

70: binder

1. A cooled charging cable for an electric vehicle, comprising:
a cable part;
at least one conductor part surrounding the cable part;
at least one cooling part disposed in the conductor part; and
an outer sheath surrounding the cable part and the conductor part.

2. The cooled charging cable of claim 1, wherein the cable part includes a ground line and a plurality of power lines disposed to contact each other inside the outer sheath.

3. The cooled charging cable of claim 2, further comprising a central tension line disposed between the ground and the power lines and formed of any one selected from among carbon, urethane, and glass which are non-metallic fibers.

4. The cooled charging cable of claim 1, wherein the conductor part includes a first curved part surrounding any one cable part, a second curved part surrounding another cable part and formed on a side of the first curved part, and a third curved part connecting the first curved part and the second curved part and facing an inner surface of the outer sheath.

5. The cooled charging cable of claim 1, wherein the conductor part is formed of a filling object of any one selected from among a thermoplastic elastomer, an olefin-based, urethane-based, amide-based, and polyester-based elastomer.

6. The cooled charging cable of claim 1, wherein the cooling part is a cooling tube embedded in the conductor part or a refrigerant passage formed along a length direction of the conductor part, wherein at least one cooling tube or refrigerant passage is disposed in the conductor part, or the cooling tube and the refrigerant passage both are disposed in the conductor part.
